(19) United States
(12) Patent Application Publication
(10) Pub. No.: US 2007/0084695 A1
(43) Pub. Date: Apr. 19, 2007

(54) BILL ACCEPTOR

(75) Inventor: Cheng-Kang Yu, TAIPEI (TW)

Correspondence Address: INTERNATIONAL CURRENCY TECHNOLOGIES CORPORATION, 2F-4. NO. 148, SEC. 4, CHUNG HSIAN EAST ROAD, TAIPEI, TW

(73) Assignee: INTERNATIONAL CURRENCY TECHNOLOGIES CORPORATION, Nei-Hu District, Taipei City (TW)

(21) Appl. No.: 11/163,359

(22) Filed: Oct. 17, 2005

(51) Int. Cl. G07F 7/04

(52) U.S. Cl. 194/206

(57) ABSTRACT

A bill acceptor in which a detector unit that detects the authenticity of a inserted bill is formed of a bottom detector member and a top detector member, each detector member having a plurality of detection through holes for the passing of a detection signal and a light permeable division plate detachably fastened to the respective detector member to protect the detection through holes against outside moisture.

### BACKGROUND OF THE INVENTION

1. Field of the Invention

The present invention relates to a bill acceptor for use in a coin exchanging machine or vending machine and more particularly, to such a bill acceptor of which each detector member of the detector unit is detachably mounted with a division plate for protection against outside moisture.

2. Description of the Related Art

Following fast development of technology, our living style has been changed. Various automatic vending machines (card dispensers, ticket vending machines, coin exchanging machines, etc.) are used everywhere to sell different products without the service of any serviceman. After installation of an automatic vending machine, the provider does not send any person to take care of the machine unless a new supply or repair work is needed. During the vulnerable period where no guard is in presence to protect the machine, criminals may try different measures or use different tools to steal bills from the machine. Further, because several machines may be installed in one spot to serve consumers and because the bill boxes of conventional automatic vending machines do not provided with security means, workers of the vending machine provider may have chance to pilfer bills from the machines.

Further, an automatic vending machine or coin-exchanging machine may be provided with a bill acceptor that uses a detector unit to verify the authenticity of the inserted bill. However, because an automatic vending machine or coin exchanging machine may be installed in a street side, the internal circuit and electronic device of the detector unit of the bill acceptor may be moistened by moisture in air, resulting in a function failure of the detector unit.

A waterproof structure is set in the detector unit of a coin-exchanging machine, wherein the detector unit is comprised of a bottom detector member and a top detector member. The top and bottom detector members each comprise a holder base, which has a plurality of detection through holes for the passing of a detection signal, and a division plate that protects the detection through hole against outside moisture. This waterproof structure is functional. However, because the division plate is fixedly fastened to the respective holder base, it is not detachable. When the division plate starts to wear or is damaged by an external device, bill acceptor may unable to function well. In this case, the division plate must be changed. However, it takes much time and labor to replace the division plate.

### SUMMARY OF THE INVENTION

The present invention has been accomplished under the circumstances in view. According to one aspect of the present invention, the detector unit of the bill acceptor is comprised of a bottom detector member and a top detector member. The detector member each have a plurality of detection through holes for the passing of a detection signal, and a division plate that admits light and protects the detection through hole against outside moisture. According to another aspect of the present invention, the division plate is detachably fastened to the holder base of the respective detector member. When the division plate starts to wear or is damaged, it can conveniently be detached from the respective holder base for a replacement. Further, the division plate admits light so that detection signal can pass through the detection through holes of the respective detector member to verify the authenticity of the bill passing through a gap between the top and bottom detector members.

### BRIEF DESCRIPTION OF THE DRAWINGS

FIG. 1 is an elevational view of a bill acceptor according to the present invention.

FIG. 2 is an exploded view of the bill acceptor according to the present invention.

FIG. 3 is an exploded of the bottom detector member of the detector unit of the bill acceptor according to the present invention.

FIG. 4 is an exploded of the top detector member of the detector unit of the bill acceptor according to the present invention

FIG. 5 is a sectional side view of the detector unit of the bill acceptor according to the present invention.

FIG. 6 is an exploded view of an alternate form of the bottom detector member of the detector unit of the bill acceptor according to the present invention.

FIG. 7 is an exploded view of an alternate form of the top detector member of the detector unit of the bill acceptor according to the present invention.

### DETAILED DESCRIPTION OF THE PREFERRED EMBODIMENT

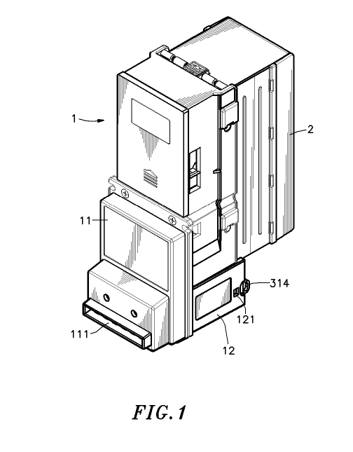

Referring to FIGS. 1˜4, a bill acceptor in accordance with the present invention is shown comprised of a housing 1, a bill box 2, and a detector unit 3.

The housing 1 has an insertion slot 111 in a face panel 11 thereof. The detector unit 3 is comprised of a bottom detector member 31 and a top detector member 32, and fastened to the back side of the housing 1 for verifying the authenticity of a bill inserted into the insertion slot 111, for enabling the verified bill to be delivered to the bill box 2 by a driving mechanism and a bill holding down mechanism (not shown) in the housing 1. The bill box 2 is pivotally fastened to the back side of the housing 1.

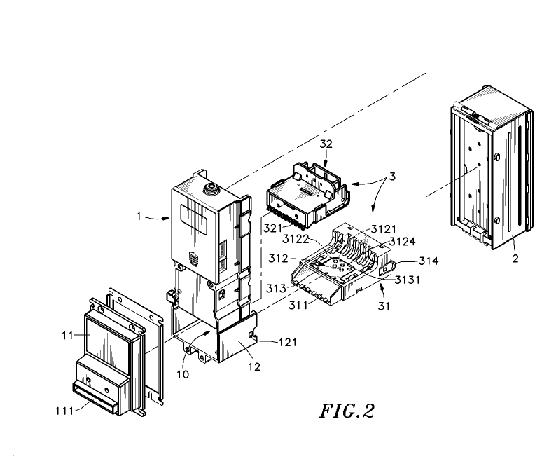

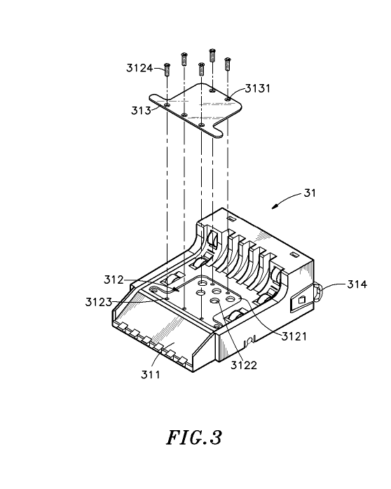

Referring to FIGS. 2 and 3 again, the bottom detector member 31 comprises a holder base 311 and a T-shaped division plate 313. The holder base 311 is injection-molded from plastics. The T-shaped division plate 313 admits light, and is injection-molded from fiber-reinforced plastics. The holder base 311 has a top detecting face 312, a plurality of detection through holes 3122 and a plurality of mounting screw holes 3123 formed in the top detecting face 312, and a recessed receiving portion 3121 formed in the detecting side 312 above the detection through holes 3122 and the mounting screw holes 3123. The division plate 313 is fitted into the recessed receiving portion 3121 at the top detecting face 312 of the bottom detector member 31, having a plurality of mounting screw holes 3131 respectively fastened to the mounting screw holes 3123 of the bottom detector member 31 with respective screws 3124. The bottom detector member 31 further comprises two retaining rods 314 bilaterally disposed at the back side for fastening to respective retaining holes 121 at the back side of the housing 1 to secure the bottom detector member 31 to the housing 1 after insertion of the holder base 311 of the bottom detector member 31 into an accommodating chamber 10 inside the housing 1.

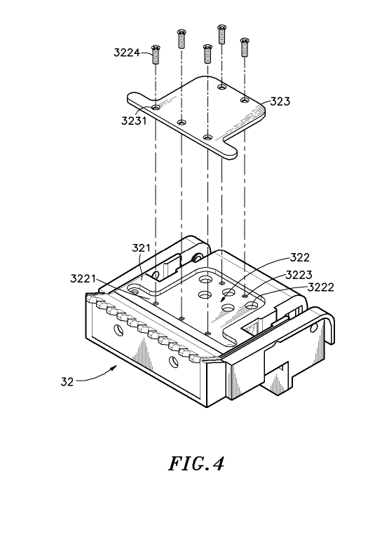

Referring to FIGS. 2 and 4 again, the top detector member 32 comprises a holder base 321 and a T-shaped division plate 323. The holder base 321 is injection-molded from plastics. The T-shaped division plate 323 admits light, and is injection-molded from fiber-reinforced plastics. The holder base 321 has a bottom detecting face 322, a plurality of detection through holes 3222 and a plurality of mounting screw holes 3223 formed in the bottom detecting face 322, and a recessed receiving portion 3221 formed in the bottom detecting face 322 below the detection through holes 3222 and the mounting screw holes 3223. The division plate 323 is fitted into the recessed receiving portion 3221 at the bottom detecting face 322 of the holder base 321, having a plurality of mounting screw holes 3231 respectively fastened to the mounting screw holes 3223 of the top detector member 32 with respective screws 3224.

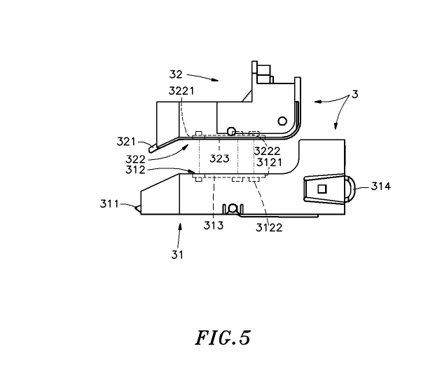

Referring to FIG. 5 and FIG. 2 again, the top detector member 32 is mounted in the accommodating chamber 10 of the housing 1 at the spaced above the bottom detector member 31 at a gap with the bottom detecting face 322 facing the top detecting face 312 of the holder base 311 of the bottom detector member 31, keeping the detection through holes 3222 of the top detector member 32 respectively aimed at the detection through holes 3122 of the bottom detector member 31 for the transmitting of detection signal. The bill that is inserted through the insertion slot 111 of the housing 1 is delivered through the gap between the division plate 313 of the bottom detector member 31 and the division plate 323 of the top detector member 32 for verification. Further, the division plate 313 or 323 seals the respective detection face 312 or 322 against outside moisture, preventing permeation of moisture into the inside of the respective detection face 312 or 322 to damage the internal circuit of the respective detector member 31 or 32 or to cause a short circuit. Further, if the division plates 313 or 323 starts to wear due to a long use or is damaged by an external object, it can conveniently detached from the respective holder base 311 or 321 for a replacement.

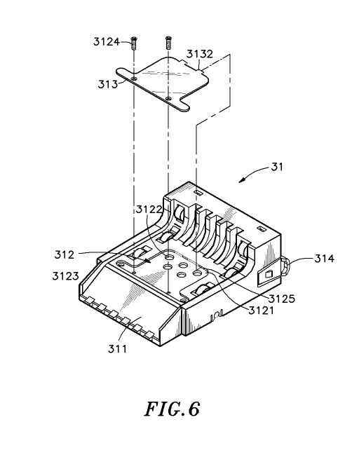

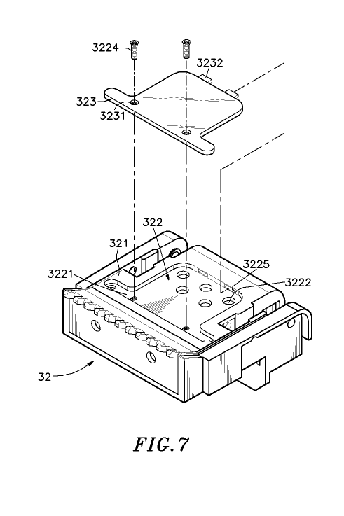

FIGS. 6 and 7 show an alternate form of the present invention. According to this embodiment, the division plate 313 or 323 has a plurality of protruding positioning portions 3132 or 3232 for engaging into respective positioning grooves 3125 or 3225 in the recessed receiving portion 3121 or 3221 of the holder base 311 or 321 of the detector member 31 or 32.

As indicated above, the invention provides a bill acceptor that has the following features.

1. The detecting face 312 or 322 of the holder base 311 or 321 of each detector member 31 or 32 has a recessed receiving portion 3121 or 3221 with/without positioning grooves 3125 or 3225 for receiving the division plate 313 or 323, for enabling the light-penetrable division plate 313 or 323 to detachably fastened to the holder base 311 or 321 with screws 3124 or 3224 to seal the detecting face 312 or 322 against outside moisture. When the division plate 313 or 323 starts to wear or is damaged, it can conveniently be detached from the holder base 311 or 321 for a replacement.

2. The division plates 313 and 323 admit light so that detection signal can pass through the detection through holes 3122 and 3222 to verify the authenticity of the bill passing through the gap between the division plates 313 and 323 of the detector members 31 and 32.

3. The division plates 313 and 323 seal the respective detecting faces 312 and 322 of the respective holder bases 311 and 321 of the respective detector members 31 and 32, preventing outside moisture from passing through the detection through holes 3122 and 3222 to the inside of the respective detector members 31 and 32 to further moisten the internal circuit and electronic devices in the respective holder bases 311 and 321 of the respective detector members 31 and 32.

A prototype of bill acceptor has been constructed with the features of FIGS. 1˜7. The bill acceptor functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A bill acceptor comprising:
a housing, said housing having an insertion slot in a face panel thereof through which a bill is insertable into the inside of said housing;
a detector unit mounted in said housing and adapted to verify the authenticity of said bill been inserted through said insertion slot into said housing; and
a bill box adapted to receive said bill verified by said detector unit;
wherein said detector unit comprises:
a bottom detector member, said bottom detector member comprising a holder base, said holder base of said bottom detector member comprising a top detecting face, a plurality of mounting screw holes formed in said top detecting face, a plurality of detection through holes formed in said top detecting face for the passing of a detection signal, and a recessed receiving portion formed in said top detecting face above said mounting screw holes and said detection through holes of said holder base of said bottom detector member, a division plate fitted into said recessed receiving portion in said top detecting face of said bottom detector member to protect said detection through holes of said bottom detector member against outside moisture, said division plate of said bottom detector member admitting light and having a plurality of mounting screw holes, and a plurality of screws respectively mounted in said mounting screw holes of said division plate of said bottom detector member and said mounting screw holes of said holder base of said bottom detector member to detachably fasten said division plate of said bottom detector member to said holder base of said bottom detector member; and
a top detector member set above said bottom detector member, said top detector member comprising a holder base, said holder base of said top detector member comprising a bottom detecting face facing said top detecting face of said bottom detector member, a plurality of mounting screw holes formed in said bottom detecting face, a plurality of detection through holes formed in said bottom detecting face for the passing of a detection signal, and a recessed receiving portion formed in said bottom detecting side below said mounting screw holes and said detection through holes of said holder base of said top detector member, a division plate fitted into said recessed receiving portion in said bottom detecting face of said top detector member to protect said detection through holes of said top detector member against outside moisture, said division plate of said top detector member admitting light and having a plurality of mounting screw holes, and a plurality of screws respectively mounted in said mounting screw holes of said division plate of said top detector member and said mounting screw holes of said holder base of said top detector member to detachably fasten said division plate of said top detector member to said holder base of said top detector member.

2. The bill acceptor as claimed in claim 1, wherein said division plates of said bottom detector member and said top detector member each have a substantially T-shaped profile.

3. The bill acceptor as claimed in claim 1, wherein said bill box is pivotally fastened to a back side of said housing.

4. The bill acceptor as claimed in claim 1, wherein said housing comprises an accommodating chamber, which accommodates said detector unit, and two retaining holes bilaterally disposed at a back side thereof for the positioning of said bottom detector member of said detector unit.

5. The bill acceptor as claimed in claim 4, wherein said holder base of said bottom detector member comprises two retaining rods bilaterally disposed at a back side thereof and respectively fastened to said retaining holes of said housing.

6. The bill acceptor as claimed in claim 4, wherein said bottom detector member is mounted in said accommodating chamber of said housing at a bottom side, and said top detector member is mounted in said accommodating chamber of said housing at a top side and vertically spaced from said bottom detector member by a gap.

7. The bill acceptor as claimed in claim 1, wherein said detection through holes of said top detector member are respectively vertically aimed at said detection through holes of said bottom detector member.

8. The bill acceptor as claimed in claim 1, wherein said division plates of said top detector member and said bottom detector member are transparent or semi-transparent.

9. A bill acceptor comprising:
a housing, said housing having an insertion slot in a face panel thereof through which a bill is insertable into the inside of said housing;
a detector unit mounted in said housing and adapted to verify the authenticity of said bill been inserted through said insertion slot into said housing; and
a bill box adapted to receive said bill verified by said detector unit;
wherein said detector unit comprises:
a bottom detector member, said bottom detector member comprising a holder base, said holder base of said bottom detector member comprising a top detecting face, a plurality of detection through holes formed in said top detecting face for the passing of a detection signal, a recessed receiving portion formed in said top detecting face above said detection through holes of said holder base of said bottom detector member, and a plurality of positioning grooves respectively extending from said recessed receiving portion of said bottom detector member, a division plate fitted into said recessed receiving portion in said top detecting face of said bottom detector member to protect said detection through holes of said bottom detector member against outside moisture, said division plate of said bottom detector member admitting light and having a plurality of protruding positioning portions respectively detachably engaged into said positioning grooves of said holder base of said bottom detector member; and
a top detector member set above said bottom detector member, said top detector member comprising a holder base, said holder base of said top detector member comprising a bottom detecting face, a plurality of detection through holes formed in said bottom detecting face for the passing of a detection signal, a recessed receiving portion formed in said bottom detecting face below said detection through holes of said holder base of said top detector member, and a plurality of positioning grooves respectively extending from said recessed receiving portion of said top detector member, a division plate fitted into said recessed receiving portion in said bottom detecting face of said top detector member to protect said detection through holes of said top detector member against outside moisture, said division plate of said top detector member admitting light and having a plurality of protruding positioning portions respectively detachably engaged into said positioning grooves of said holder base of said top detector member.

10. The bill acceptor as claimed in claim 9, wherein said division plates of said bottom detector member and said top detector member each have a substantially T-shaped profile.

11. The bill acceptor as claimed in claim 9, wherein said bill box is pivotally fastened to a back side of said housing.

12. The bill acceptor as claimed in claim 9, wherein said housing comprises an accommodating chamber, which accommodates said detector unit, and two retaining holes bilaterally disposed at a back side thereof for the positioning of said bottom detector member of said detector unit.

13. The bill acceptor as claimed in claim 12, wherein said holder base of said bottom detector member comprises two retaining rods bilaterally disposed at a back side thereof and respectively fastened to said retaining holes of said housing.

14. The bill acceptor as claimed in claim 12, wherein said bottom detector member is mounted in said accommodating chamber of said housing at a bottom side, and said top detector member is mounted in said accommodating chamber of said housing at a top side and vertically spaced from said bottom detector member by a gap.

15. The bill acceptor as claimed in claim 9, wherein said detection through holes of said top detector member are respectively vertically aimed at said detection through holes of said bottom detector member.

16. The bill acceptor as claimed in claim 9, wherein said division plates of said top detector member and said bottom detector member are transparent or semi-transparent.
